(19) United States
(12) Patent Application Publication
(10) Pub. No.: US 2009/0028426 A1
(43) Pub. Date: Jan. 29, 2009

(54) Coloring picture, coloring picture generating apparatus, and coloring picture generating method

(75) Inventor: Yoichiro Maki, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/220,753

(22) Filed: Jul. 28, 2008

(30) Foreign Application Priority Data
Jul. 26, 2007 (JP) 2007-194517

(51) Int. Cl. G06K 9/34

(52) U.S. Cl. 382/164

(57) ABSTRACT

A watercolor effect-added coloring picture 10 includes original image color areas 16 formed along linework areas 12 to be extended in a predetermined range from the linework areas 12 and filled with specified colors based on the colors of an original image, and blank areas 14 formed adjacent to the original image color areas 16. The linework areas 12 are filled with an achromatic gray color having a high luminance value, while the original image color areas 16 are filled with chromatic colors and are formed to have higher luminance values than the luminance value of the linework areas 12. This arrangement gives the watercolor effect as one illusion effect that creates the optical illusion of spread of a paler color over a neighboring area adjacent to a paler color line of two-color double lines. Although the blank areas 14 are actually not filled with any colors, the watercolor effect gives the illusion of the spread of the specified colors of the original image color areas 16 over the whole blank areas 14. The original image color areas 16 are formed in a width as narrow in width as the linework areas 12 and thus do not significantly disturb the user s coloring of the coloring picture 10 even with different colors from those of the original image.

### BACKGROUND OF THE INVENTION

1. Field of the Invention

The present invention relates to a coloring picture, a coloring picture generating apparatus, and a coloring picture generating method.

2. Description of the Related Art

One proposed technique for a coloring picture generating apparatus detects areas with luminance values of not greater than a preset threshold luminance value in an original image as ink line areas, adjacent areas surrounding the ink line areas as neighboring areas, and remaining areas other than the ink line areas and the neighboring areas as contour areas. This prior art technique then allocates different colors to the ink line areas and the contour areas and to the other areas to generate a coloring picture (see, for example, Japanese Patent Laid-Open No. 2004-334303). This aims to produce a natural line drawing from an original image with partially enhanced edge effects.

### SUMMARY OF THE INVENTION

This prior art coloring picture generating apparatus in the above cited reference, however, may not inform the user of a correct original image as the base of a generated coloring picture. The possible measure against this problem is, for example, attaching a color print of the original image to the generated coloring picture or printing a color thumbnail of the original image at one corner of the generated coloring picture. The former method, however, undesirably increases the total number of prints, whereas the latter method may cause the printed thumbnail to spoil a resulting colored picture as one finish work.

In the coloring picture, the coloring picture generating apparatus, the coloring picture generating method, and the coloring picture generating program, there would thus be a demand for enabling the user to color a generated coloring picture by referring to the color tendency of an original image without using any additional image other than the generated coloring picture. In the coloring picture, the coloring picture generating apparatus, the coloring picture generating method, and the coloring picture generating program, there would also be a demand for ensuring that the colors used for generating the coloring picture do not significantly disturb the user's picture coloring.

The present invention accomplishes at least part of the demands mentioned above and the other relevant demands by the following configurations applied to the coloring picture, the coloring picture generating apparatus, and the coloring picture generating method.

According to one aspect, the present invention is directed to a coloring picture including: a linework area formed as an area of line segments; an original image color area formed along the linework area to be extended in a predetermined range from the linework area and filled with a specified color based on a color of an original image; and a blank area formed adjacent to the original image color area.

In the coloring picture according to this aspect of the invention, the original image color area is formed along the linework area to be extended in the predetermined range from the linework area and is filled with the specified color based on the color of the original image. The blank area is formed adjacent to the original image color area. Formation of the original image color area, which is filled with the specified color based on the color of the original image, between the linework area and the blank area as an object area of picture coloring enables the user to refer to the color tendency of the original image and color the generated coloring picture by using the generated coloring picture alone. The ‘specified color based on the color of the original image’ may be identical with the color of the original image or a similar to the color of the original image (for example, a brighter color than the corresponding color of the original image).

In one preferable application of the coloring picture of the present invention, the linework areas are filled with an achromatic color, while the original image color area is filled with a chromatic color and is formed to have a higher luminance value than a luminance value of the linework area.

In one preferable application of the coloring picture of the present invention, the original image color area is formed along the linework area to have a width equivalent to or less than a width of the linework area as the predetermined range.

In another preferable application of the coloring picture of the present invention, the original image color area is formed along the linework area to have a width of not less than 0.5 mm and not greater than 2.0 mm or even not greater than 1.0 mm as the predetermined range. The width of the linework areas may be specified in a range of not less than 0.5 mm and not greater than 5.0 mm. The linework areas may have a width of not greater than 2.0 mm or even not greater than 1.0 mm.

According to another aspect, the present invention is directed to a coloring picture generating apparatus configured to generate a coloring image from an original image having multiple color areas. The coloring picture generating apparatus includes: an area extraction module configured to detect a boundary between adjacent color areas and extract a predetermined range from the detected boundary as a boundary area; and an image generation module configured to specify a remaining area other than the extracted boundary area as a blank area and fill the extracted boundary area with a specified color based on a color of the original image, so as to generate the coloring image.

The coloring picture generating apparatus according to this aspect of the invention detects the boundary between the adjacent color areas, and extracts the predetermined range from the detected boundary as the boundary area. The coloring picture generating apparatus specifies the remaining area other than the extracted boundary area as the blank area, and fills the extracted boundary area with the specified color based on the color of the original image, thus generating the coloring image. The boundary area in the predetermined range to be filled with the specified color based on the color of the original image is formed adjacent to the blank area as the object area of picture coloring. This arrangement enables the user to refer to the color tendency of the original image and color the generated coloring image by using the generated coloring image alone.

In one preferable application of the coloring picture generating apparatus according to this aspect of the invention, the image generation module fills the extracted boundary area with the specified color of a higher luminance value than a luminance value of the color of the original image, so as to generate the coloring image. In an original image including a color area representing the image contour (a color area filled with an achromatic color of a low luminance value, for example, black), the water color effect as one illusion effect creates the optical illusion of spread of a paler color over a neighboring area adjacent to a paler color line of two-color double lines. This watercolor effects facilitates the user's grasp of the color tendency of the original image by using the generated coloring image alone.

In another preferable application of the coloring picture generating apparatus according to the above aspect of the invention, the area extraction module creates an area detection image as a basis for extraction of the boundary area, detects information on an extraction range of the boundary area from the created area detection image, and extracts the boundary area from the original image based on the detected information. In this application, the area extraction module may perform at least one of a blurring process and an edge enhancement process on the area detection image and detect an edge of the processed area detection image, in order to detect the information on the extraction range of the boundary area from the area detection image.

In still another preferable application of the coloring picture generating apparatus according to the above aspect of the invention, the area extraction module extracts the boundary area along the boundary to have a preset width from the boundary between the adjacent color areas. In this application, it is preferable that the area extraction module extracts the boundary area along the detected boundary in a width of not less than 0.5 mm and not greater than 2.0 mm from the boundary as the preset width. It is especially preferable that the area extraction module extracts the boundary area in a width of not greater than 1.0 mm.

The coloring picture generating apparatus of the present invention may further include a print execution module to print the coloring image generated by the image generation module on a printing medium.

The coloring picture generating apparatus of the present invention may further include an image acquisition module configured to obtain the original image from an original manuscript, as a basis for extraction of the boundary area by the area extraction module.

According to another aspect, the present invention is directed to a coloring picture generating method to generate a coloring image from an original image having multiple color areas, the coloring picture generating method comprising the steps of:

(a) detecting a boundary between adjacent color areas and extracting a predetermined range from the detected boundary as a boundary area; and

(b) specifying a remaining area other than the extracted boundary area as a blank area and filling the extracted boundary area with a specified color based on a color of the original image, so as to generate the coloring image.

The coloring picture generating method according to this aspect of the invention detects the boundary between the adjacent color areas, and extracts the predetermined range from the detected boundary as the boundary area. The coloring picture generating method specifies the remaining area other than the extracted boundary area as the blank area, and fills the extracted boundary area with the specified color based on the color of the original image, thus generating the coloring image. The boundary area in the predetermined range to be filled with the specified color based on the color of the original image is formed adjacent to the blank area as the object area of picture coloring. This arrangement enables the user to refer to the color tendency of the original image and color the generated coloring image by using the generated coloring image alone. In the coloring picture generating method of the present invention, diverse embodiments of the coloring picture generating apparatus described above may be adopted or steps to actualize respective functions of the coloring picture generating apparatus described above may be added.

The present invention is further directed to a program that causes one or multiple computers to execute the respective steps of the coloring picture generating method of the invention described above. The program of the invention may be recorded in a computer readable recording medium (for example, a hard disk, a ROM, an FD, a CD, or a DVD), may be transferred from one computer to another computer via a transfer medium (a communication network like the Internet or a LAN), or may be transmitted in any other suitable form. Only a single computer may execute all the steps or multiple computers may share execution of the steps of the coloring picture generating method of the invention. Thus, the same effects of the coloring picture generating method described above can be obtained.

### BRIEF DESCRIPTION OF THE DRAWINGS

FIG. 1 shows a watercolor effect-added coloring picture 10 in one embodiment of the present invention;

FIG. 2 shows an original image 70;

FIG. 3 schematically illustrates the structure of a printer 20;

FIG. 4 is a flowchart showing a coloring picture generating routine;

FIG. 5 shows an area detected image 71;

FIG. 6 shows extraction of boundary areas;

FIG. 7 shows an area extracted image 76; and

FIG. 8 shows one example of a gamma conversion curve applicable to such color conversion.

### DESCRIPTION OF THE PREFERRED EMBODIMENTS

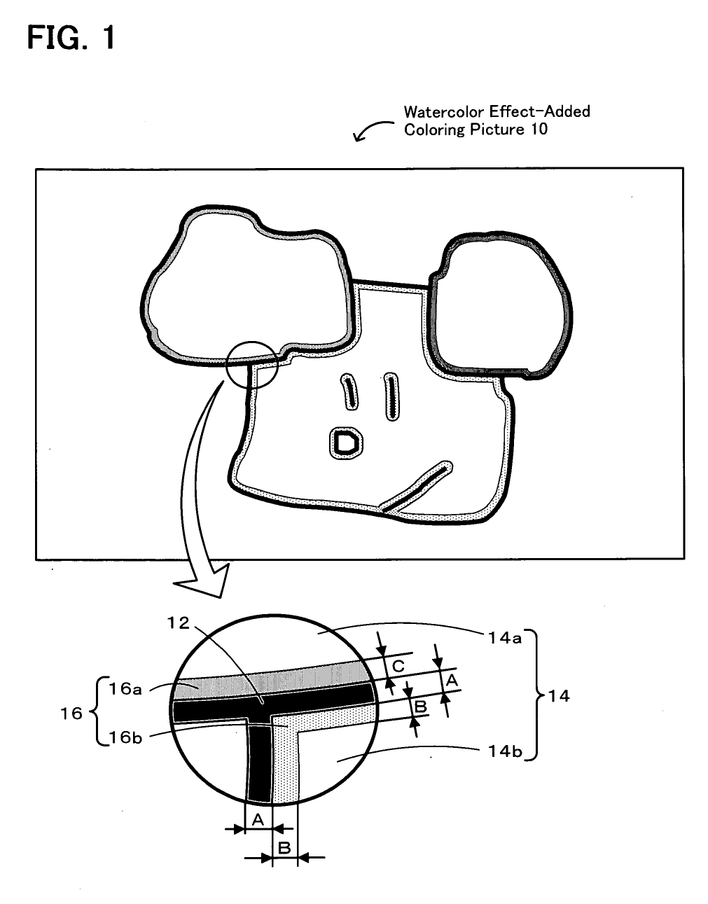

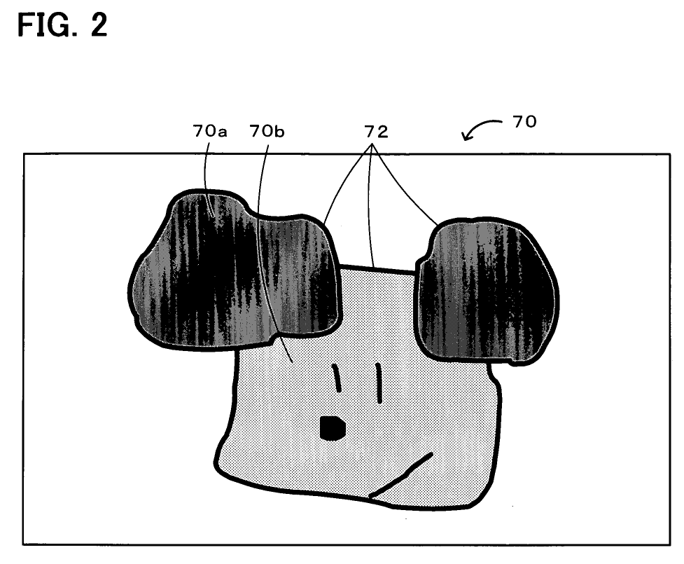

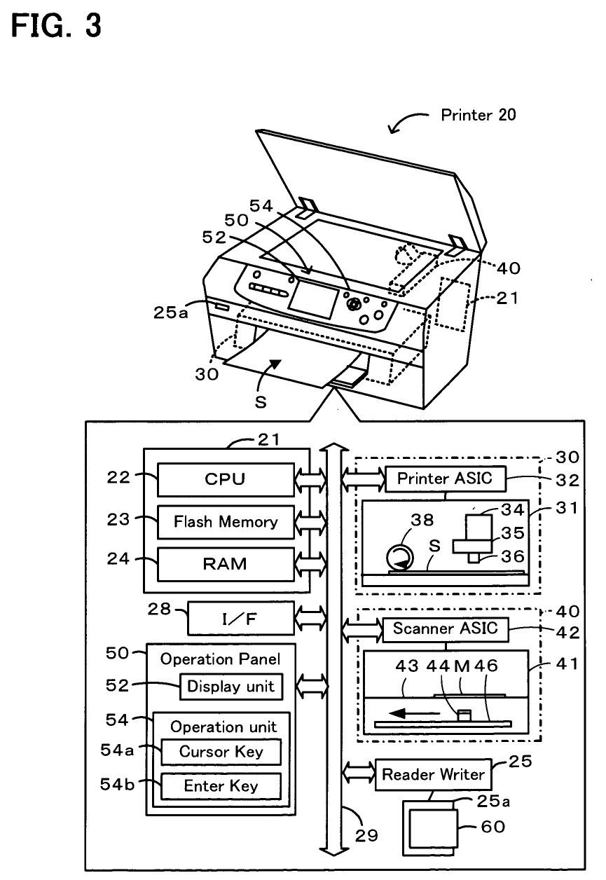

One mode of carrying out the invention is described below as a preferred embodiment with reference to the accompanied drawings. FIG. 1 shows a watercolor effect-added coloring picture 10 in one embodiment of the present invention. FIG. 2 shows an original image 70. FIG. 3 schematically illustrates the structure of a printer 20 adopted for generating the watercolor effect-added coloring picture 10.

As shown in FIG. 1, the watercolor effect-added coloring picture 10 is a coloring image printed on a size A4 of photo matte paper. The watercolor effect-added coloring picture 10 has linework areas 12 corresponding to line segments of the original image 70 (see FIG. 2), blank areas 14 as object areas of picture coloring, and original image color areas 16 each of which is formed adjacent to and between the linework area 12 and the blank area 14 to have a width in a predetermined range from the linework area 12 and is filled with a specified color based on a color of the original image 70. The linework areas 12 are filled with a gray color, which is a paler achromatic color than black used for drawing the line segments of the original image 70 (see FIG. 2). The linework areas 12 have a width A in a range of not less than 0.5 mm and not greater than 1.0 mm. This range is, however, not restrictive, and the width A of the linework areas 12 may be specified in a range of not greater than 2.0 mm or even in a range of not greater than 5.0 mm. The width A of not less than 0.5 mm enables the user's easy grasp of the image contour lines, while the width A of not greater than 5.0 mm ensures no substantial disturbance of the linework areas 12 to the user's picture coloring.

Each of the original image color areas 16 is filled with a similar but brighter chromatic color than a corresponding color of the original image 70 (see FIG. 2) and is formed to have a higher luminance value than the luminance value of the linework areas 12. The original image color area 16 has a width substantially equal to the width of the adjacent linework area 12. For example, a first original image color area 16a corresponding to a color area 70a in the original image 70 is filled with a similar but brighter color than the color of the color area 70a. A second original image color area 16b corresponding to a color area 70b in the original image 70, which is formed in a lighter color than the color of the color area 70a, is filled with a color that is similar but brighter than the color of the color area 70b and is lighter than the color of the first original image color area 16a. The original image color areas 16 including the first original image color area 16a and the second original image color area 16b are formed to have higher luminance values than the luminance value of the linework areas 12. In the original image color areas 16, the first original image color area 16a has a width B substantially equal to (equivalent to) the width A of the adjacent linework area 12, and the second original image color area 16b has a width C substantially equal to (equivalent to) the width A of the adjacent linework area 12. In this illustrated example, the original image color areas 16 are formed along the adjacent linework areas 12 in the widths of not less than 0.5 mm and not greater than 1.0 mm. The original image color areas 16 preferably have the widths equivalent to or less than the width of the linework areas 12. The above range is not restrictive, and the original image color areas 16 may be formed along the adjacent linework areas 12 in the widths of not greater than 2.0 mm. The blank areas 14 include, for example, a first blank area 14a formed inside the first original image color area 16a and a second blank area 14b formed inside the second original image color area 16b.

In the watercolor effect-added coloring picture 10 of this embodiment, the linework areas 12 are filled with an achromatic gray color, while the original image color areas 16 are formed to have the widths equivalent to or less than the width of the linework areas 12 and to have higher luminance values than the luminance value of the linework area 12. This arrangement gives the watercolor effect as one illusion effect that creates the optical illusion of spread of a paler color over a neighboring area adjacent to a paler color line of two-color double lines. In the watercolor effect-added coloring picture 10, the first blank area 14a inside the first original image color area 16a formed along the linework area 12 is actually not filled with any color but is subjected to the illusion of spread of the color of the first original image color area 16a. Similarly the second blank area 14b inside the second original image color area 16b formed along the linework area 12 is actually not filled with any color but is subjected to the illusion of spread of the color of the second original image color area 16b. This optical effect creates the illusion of colors in the whole watercolor effect-added coloring picture 10 similar to those of the original image 70. The original image color areas 16 are formed as narrow in width as the linework areas 12. The colors in the original image color areas 16 thus do not significantly disturb coloring of the watercolor effect-added coloring picture 10 even with different colors from those of the original image 70.

The description regards the structure of the printer 20 as the apparatus for generating the watercolor effect-added coloring picture 10. As shown in FIG. 3, the printer 20 is constructed as a multifunction printer having the functions of a scanner, a printer, and a copying machine. The printer 20 includes a controller 21 configured to control the operations of the whole system, a reader writer 25 equipped with a slot 25a for insertion and ejection of a memory card 60 as a portable storage medium, an interface (I/F) 28 configured to allow input and output of information from and to a connected external device, a printer module 30 constructed to include a printer ASIC (application specific integrated circuit) 32 as an IC chip for controlling a printer mechanism 31, a scanner assembly 40 constructed to include a scanner ASIC 42 as an IC chip for controlling a scanner mechanism 41, and an operation panel 50 constructed to give the user information display and allow the user's entry of instructions. The controller 21, the reader writer 25, the I/F 28, the printer module 30, the scanner module 40, and the operation panel 50 are electrically interconnected by means of a bus 29. The controller 21 is constructed as a microprocessor including a CPU 22, a flash memory 23 designed to be electrically erasable and store diversity of processing programs, and a RAM 24 designed to temporarily store data. The printer mechanism 31 includes an ink cartridge 34 structured to individually store color inks, cyan (C), magenta (M), yellow (Y), and black (K), a pressure generator 35 arranged to apply pressures to the respective color inks supplied from the ink cartridge 34, nozzles 36 constructed to eject the respective color inks pressurized by the pressure generator 35 onto a sheet of printing paper S, and a feed roller 38 designed to feed the sheet of printing paper S. The pressure generator 35 may adopt deformation of piezoelectric elements to apply the pressures to the color inks or may adopt bubbles produced by heat of built-in heaters to apply the pressures to the color inks. The scanner mechanism 41 is a flat bed type and includes a glass plate 43 arranged to keep a medium M placed thereon as an original for image scan, a scanning sensor 44 constructed to optically scan the medium M via the glass plate 43, and a moving unit 46 arranged to move the scanning sensor 44 for optically scanning the medium M. The scanning sensor 44 is a known color image sensor to receive the reflected light from the medium M and separate the reflected light into three color components, red (R), green (G), and blue (B), as scan data. The operation panel 50 is a device operated by the user for the entry of various instructions into the printer 20. The operation panel 50 has a display unit 52 including a color liquid crystal panel for display of letters, characters, and images in response to the user's entry of the various instructions and an operation unit 54 for various operations. The operation unit 54 has a cursor key 54a depressed to move the cursor for the user's selection of, for example, a desired processing operation or a desired character string or image and an enter key 54b depressed to settle the user's selection. The memory card 60 is a rewritable and erasable non-volatile memory and enables storage of various data, for example, multiple image files taken with an imaging device, such as a digital camera.

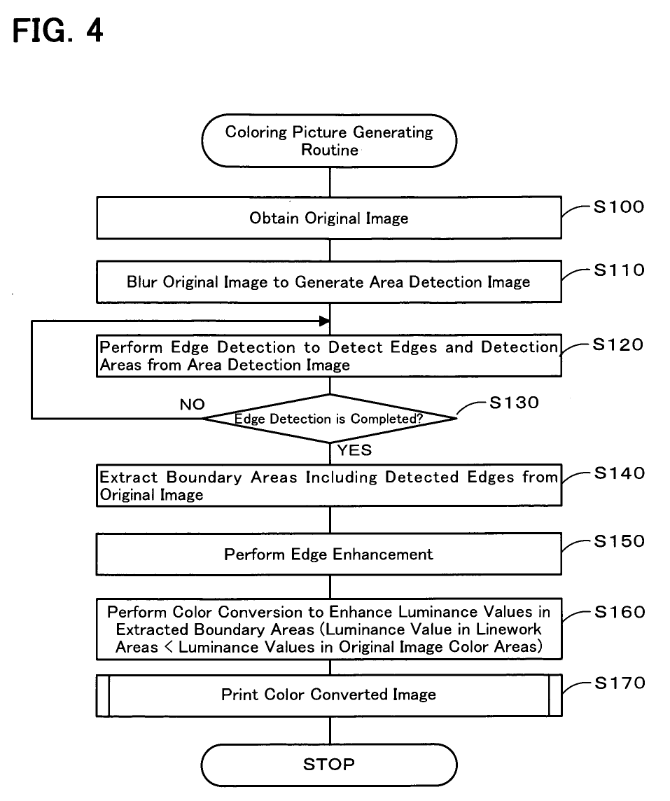

The printer 20 of the embodiment thus constructed is operated as described below. The description first regards a series of operations to generate the watercolor effect-added coloring picture 10. When the user sets a medium M with an original image for generating a coloring picture (the original image 70 in this embodiment) in the scanner module 40, a processing window (not shown) is opened on the display unit 52. The user subsequently operates the operation unit 54 to enter an instruction for generating a coloring picture from the original image obtained by scanning the medium M. In response to the user's entry of the coloring picture generating instruction, the printer 20 executes a series of operations to generate a coloring picture from the original image set in the scanner 40. FIG. 4 is a flowchart showing a coloring picture generating routine. This routine is stored in the flash memory 23 and is expected by the CPU 22 in response to the user's entry of the coloring picture generating instruction. On the start of this routine, the CPU 22 first obtains the original image 70 (step S100). According to a concrete procedure, the CPU 22 instructs the scanner ASIC 42 to drive and control the scanner mechanism 41. The scanning sensor 44 is moved by the moving unit 46 to optically scan the medium M placed on the glass plate 43 and obtain image data of the original image 70 (see FIG. 2).

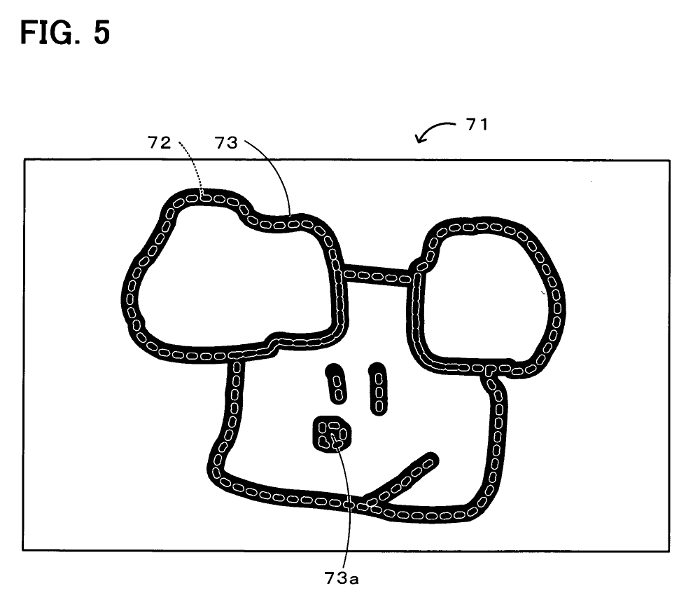

The CPU 22 subsequently duplicates the original image 70 and blurs the duplicated original image 70 to generate an area detection image (step S110). The area detection image is used to detect a boundary (hereafter referred to as ‘edge’) between each pair of color areas adjacent to each other and a peripheral area of the boundary (hereafter referred to as ‘boundary area’) from the original image 70. In this embodiment, the duplicated original image 70 is blurred by application of a Gaussian filter in a predetermined size (for example, a size of 5×5 pixels, a size of 7×7 pixels, or a size of 9×9 pixels). The intensity of the Gaussian filter is adequately determined according to a detection range of the boundary areas. The resulting blurred area detection image has line segments corresponding to the edges in the original image 70 and detection areas in a predetermined range from the respective line segments (described below with reference to FIG. 5).

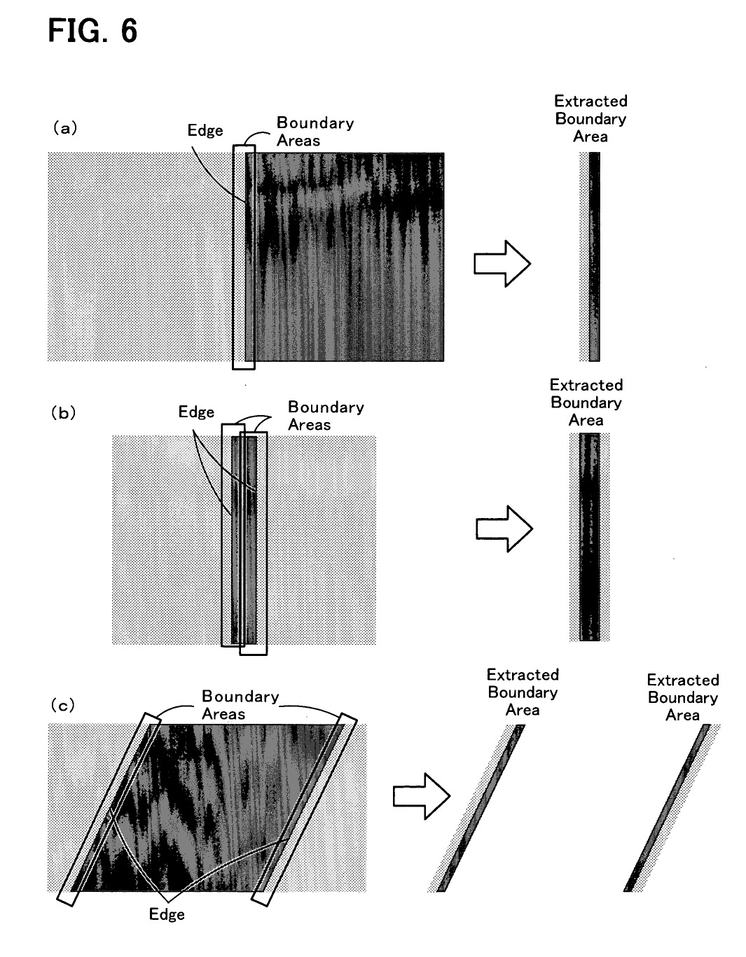

The CPU 22 then refers to the generated area detection image to perform edge detection (step S120). An edge detection filter, for example, a Sobel filter or a Laplacian filter is applied to the area detection image for the purpose of edge detection. One preferable procedure sets a lower threshold value for the edge detection to enable extraction of boundary areas in a wider range in the original image 70. FIG. 5 shows an area detected image 71. In the illustrated example of FIG. 5, the edge detection gives an area detected image 71 including line segments 72 in the original image 70 (see FIG. 2) representing the edges and detection areas 73 in a predetermined range from the respective line segments 72. The settings of the Gaussian filter, the edge detection filter, and an edge enhancement filter (explained later) are empirically determined to be suitable for the detection areas 73 extended in an identical width to both sides of the respective line segments 72. The printer 20 of this embodiment is set to extract boundary areas along edges in a predetermined range of not less than 0.5 mm and not greater than 1.0 mm from the respective edges in the original image 70 (explained later with reference to FIG. 6). This range is, however, not restrictive, and the boundary areas may be extracted in a range of not greater than 2.0 mm or even in a range of not greater than 5.0 mm. The CPU 22 determines whether the edge detection is completed for the whole area of the area detection image (step S130). The edge detection of step S120 is repeated until completion for the whole area of the area detection image. On completion of the edge detection for the whole area of the area detection image (step S130: yes), the CPU 22 extracts boundary areas including the detected edges from the original image 70 (step S140). The boundary areas extracted from the original image 70 at step S140 are equivalent to the detection areas 73 in the area detected image 71.

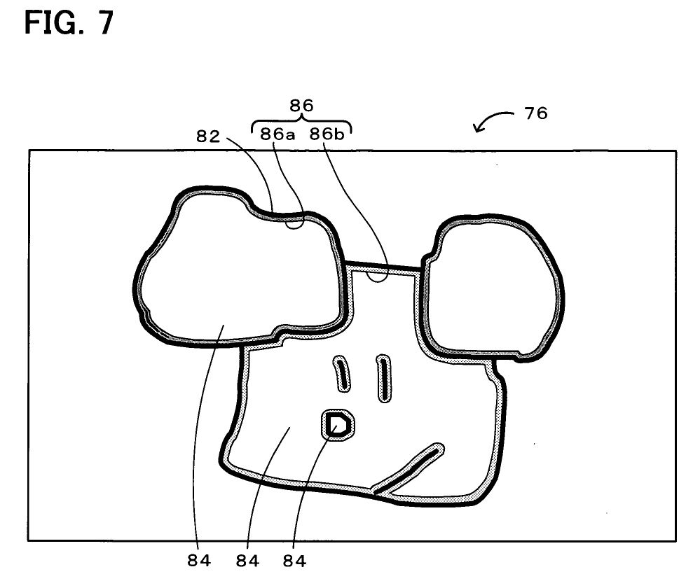

The extraction of boundary areas in a predetermined range from detected edges is described in detail with reference to FIG. 6. FIG. 6 shows extraction of boundary areas. FIG. 6(a) shows extraction of a boundary area from two adjacent color areas. FIG. 6(b) shows extraction of a boundary area from three adjacent color areas. FIG. 6(c) shows extraction of boundary areas from relatively large three adjacent color areas. In the example of FIG. 6(a), the area extracted as a boundary area is extended in a predetermined width to both sides of an edge detected as the boundary between the two adjacent color areas. In the example of FIG. 6(b), one color area (center color area) interposed between two color areas is narrow, so that two boundary areas are partly overlapped. In this case, the sum of the partly overlapped boundary areas is extracted as a boundary area of the center color area. In the example of FIG. 6(c), one color area (center color area) interposed between two color areas is sufficiently wide, so that two boundary areas are separate from each other. In this case, two separate boundary areas are extracted from the center color area. This procedure is explained with reference to the original image 70 as a concrete example. FIG. 7 shows an area extracted image 76. The area extracted image 76 is obtained by extracting the boundary areas equivalent to the detection areas 73 of the area detected image 71 from the original image 70 (see FIG. 2). The area extracted image 76 includes linework areas 82 equivalent to the line segments 72 in the original image 70 (see FIG. 2) first original image color areas 86a formed in the same width as the width of the linework areas 82 and provided corresponding to respective parts of the color areas 70a in the original image 70, and a second original image color area 86b formed in the same width as the width of the linework areas 82 and provided corresponding to part of the color area 70b in the original image 70. Outside the line segments 72 are blank areas in the original image 70, so that outside the linework areas 82 obtained by extracting the boundary areas equivalent to the detection areas 73 from the original image 70 are blank areas in the area extracted image 76. As shown in FIG. 7, inside the respective original image color areas 86 formed along the linework areas 82 are blank areas 84. In a color area exceeding a preset area range as shown in FIG. 6(c) (for example, a detection area 73a in FIG. 5), a blank area 84 is formed inside the linework area 82 as shown in FIG. 7.

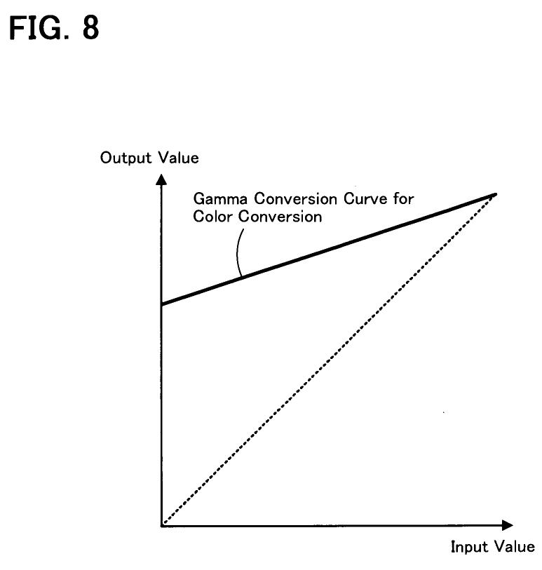

The CPU 22 successively performs edge enhancement on the area extracted image 76 including the boundary areas extracted from the original image 70 (step S150) and performs color conversion (step S160). The edge enhancement process applies a known edge enhancement filter to the area extracted image 76 to enhance the linework areas 82. The color conversion process converts the achromatic color to an achromatic color having a higher luminance value (that is, brighter gray color) and each chromatic color to a chromatic color having a higher luminance value (that is, a similar but brighter color). FIG. 8 shows one example of a gamma conversion curve applicable to such color conversion. Application of this gamma conversion curve shown in FIG. 8 to the color conversion makes the luminance values of the chromatic color areas higher than the luminance value of the achromatic color areas, while preventing a significant change in tone of the chromatic color areas in a resulting color converted image. The resulting color converted image is printed as the watercolor effect-added coloring picture 10. The CPU 22 instructs the printer ASIC 32 to drive and control the printer mechanism 31 and thereby print the resulting color-converted image on the sheet of printing paper S (step S170) and terminates this coloring picture generating routine. According to a concrete procedure, the CPU 22 outputs image data to the printer ASIC 32. The printer ASIC 32 expands the input image data into bitmap image data in a print buffer of the RAM 24 and controls the pressure generator 35 and the feed roller 38 of the printer mechanism 31 to eject the corresponding color inks from the ink cartridge 34 onto the sheet of printing paper S according to the expanded data. The resulting printed image is the watercolor effect-added coloring picture 10 of FIG. 1, which includes the linework areas 12 of the achromatic color with the higher luminance value than the achromatic color luminance value of the original image and the original image color areas 16 formed along the linework areas 12 to be extended in a predetermined width and have the higher luminance values than the chromatic color luminance values of the original image.

The constituents in the embodiment are mapped to the constituents in the claims of the invention as described below. The CPU 22 of this embodiment is equivalent to the area extraction module and the image generation module of the invention. The printer module 30, the scanner module 40, and the sheet of printing paper S of the embodiment respectively correspond to the print execution module, the image acquisition module, and the printing medium of the invention. The embodiment describes the operations of the printer 20 to elucidate the coloring picture generating method of the invention.

As described above, the watercolor effect-added coloring picture 10 of this embodiment includes the original color image areas 16 formed along the linework areas 12 to be respectively extended in a predetermined range and filled with specified chromatic colors based on the chromatic colors in the original image, and the blank areas 14 formed adjacent to the original image color areas 16. Formation of such original image color areas 16 filled with the corresponding chromatic colors based on the chromatic colors of the original image between the linework areas 12 and the blank areas 14 as the object areas of picture coloring enables the user to use the watercolor effect-added coloring picture 10 alone and color the coloring picture 10 with reference to the color tendency of the original image. The arrangement of the embodiment does not require a color print of the original image as a reference for picture coloring and thus desirably reduces consumption of the inks and the printing paper S. The arrangement of the embodiment also enables reference to the color tendency of the original image without spoiling a resulting colored picture as a final work, compared with attachment of a thumbnail as a contracted original image as part of the coloring picture. The linework areas 12 are filled with an achromatic color, while the original image color areas 16 are filled with corresponding chromatic colors based on the colors of the original image and are formed to have the higher luminance values than the luminance value of the linework areas 12. This arrangement gives the watercolor effect and ensures the user's easy grasp of the color tendency of the original image by referring to only the generated coloring picture 10. The linework areas 12 are filled with gray, the light achromatic color, and do not thus significantly disturb the user's picture coloring. The original image color areas 16 are formed in substantially the same width as the width of the linework areas 12 and thus do not significantly disturb the user's picture coloring. The original image color areas 16 have the width of not less than 0.5 mm and thereby ensure the user's easy grasp of the color tendency of the original image. The original image color areas 16 have the width of not greater than 1.0 mm and thereby dot not disturb the user's picture coloring. The linework areas 12 have the width of not less than 0.5 mm and thereby ensure the user's easy grasp of the contours of the original image. The linework areas 12 have the width of not greater than 1.0 mm and thereby do not disturb the user's picture coloring.

In the printer 20 of the embodiment, the line segments 72 and the detection areas as parts of the color areas 70a and 70b adjacent to the line segments 72 in the original image 70 are extracted as the boundary areas including the linework areas and the original image color areas. The remaining areas other than the extracted linework areas and the extracted original image color areas are specified as blank areas in the area extracted image. The original image color areas in the generated coloring picture are filled with the corresponding chromatic colors based on the chromatic colors of the original image. Formation of such original image color areas filled with the corresponding chromatic colors based on the chromatic colors of the original image between the linework areas and the blank areas as the object areas of picture coloring enables the user to use the generated coloring picture alone and color the coloring picture with reference to the color tendency of the original image. The extracted linework areas are filled with an achromatic color, while the extracted original image color areas are filled with the corresponding chromatic colors based on the colors of the original image and are formed to have the higher luminance values than the luminance value of the linework areas. This arrangement gives the watercolor effect and ensures the user's easy grasp of the color tendency of the original image by referring to only the generated coloring picture. The color of the extracted linework areas is converted to an achromatic color having the higher luminance value than the luminance value of the achromatic color used in the original image. The colors of the extracted original image color areas are converted to chromatic colors having the higher luminance values than both the luminance value of the converted achromatic color of the linework areas and the luminance values of the chromatic colors used in the original image. The color of the linework areas and the colors of the original image color areas formed in advance in the generated coloring picture thus do not significantly disturb the user's coloring picture. The original image color areas are formed in substantially the same width as the width of the linework areas and thus do not significantly disturb the user's picture coloring. The original image color areas have the width of not less than 0.5 mm and thereby ensure the user's easy grasp of the color tendency of the original image. The original image color areas have the width of not greater than 1.0 mm and thereby dot not disturb the user's picture coloring. The linework areas have the width of not less than 0.5 mm and thereby ensure the user's easy grasp of the contours of the original image. The linework areas have the width of not greater than 1.0 mm and thereby do not disturb the user's picture coloring. The printer 20 of the embodiment separately generates the area detection image from the obtained original image and detects the information on the extraction range of the linework areas and the original image color areas from the generated area detection image. This area detection image has the higher degree of freedom in image processing than the original image and ensures the easier extraction of the linework areas as the edges of the original image. The area detection image is obtained by blurring the obtained original image. Such blurring operation expands the linework areas as the edges and enables extraction of the expanded linework areas as the boundary areas formed in the predetermined range from the edges. This enables the linework areas and the original image color areas to be extracted collectively as the boundary areas. The printer 20 of the embodiment has the printer module 30 to print a resulting processed image as a coloring picture on the sheet of print paper S and the scanner module 40 to scan the original image for readily generating a coloring picture from the original image.

The embodiment discussed above is to be considered in all aspects as illustrative and not restrictive. There may be many modifications, changes, and alterations without departing from the scope or spirit of the main characteristics of the present invention.

In the watercolor effect-added coloring picture 10 of the embodiment, the linework areas 12 are filled with gray, the light achromatic color, while the original image color areas 16 are filled with the corresponding chromatic colors based on the colors of the original image and are formed to have the higher luminance values than the luminance value of the linework areas 12. This arrangement is, however, neither essential nor restrictive. In an original image including at least two color areas, the linework areas 12 may be filled with black or a selected chromatic color, and the original image color areas 16 may be filled with an achromatic color and may be formed to have the lower luminance value than the luminance value of the linework areas 12. As long as the original image color areas 16 are formed based on the colors of the original image 70, the user can refer to the color tendency of the original image and color the generated coloring picture by using the generated coloring picture alone.

In the watercolor effect-added coloring picture 10 of the embodiment, the original image color areas 16 are formed in substantially the same width as the width of the linework areas 12. The width of the original image color areas 16 may, however, be smaller than the width of the linework areas 12 or may be greater than the width of the linework areas 12. In the embodiment described above, the original image color areas 16 are formed in the width range of 0.5 mm to 2.0 mm, and the linework areas 12 are formed in the width range of 0.5 mm to 5.0 mm. These ranges are, however, not restrictive, but the original image color areas 16 and the linework areas 12 may be formed in the widths greater than these ranges. Such modification still enables the user to refer to the color tendency of the original image and color the generated coloring picture by using the generated coloring picture alone.

The coloring picture generating routine of the embodiment performs the color conversion at step S160 by application of the gamma conversion curve to convert the achromatic color of the extracted linework areas 12 to an achromatic color having a higher luminance value than the luminance value of the achromatic color in the original image 70 and to convert the chromatic colors of the extracted original image color areas 16 to chromatic colors having higher luminance values than the luminance value of the achromatic color of the converted linework areas 12 and the luminance values of the chromatic colors in the original image 70. Such color conversion may be omitted when not required. The omission of the color conversion gives the linework areas 12 and the original image color areas 16 filled with the original darker colors having the lower luminance values. Such modification still enables the user to refer to the color tendency of the original image and color the generated coloring picture by using the generated coloring picture alone.

The coloring picture generating routine of the embodiment separately generates the area detection image from the obtained original image at step S110 and detects the information on the extraction range of the linework areas 12 and the original image color areas 16 from the generated area detection image at step S120. The generation of the area detection image is, however, not essential. The linework areas 12 and the original image color areas 16 may be directly extracted from the original image 70 without generation of the area detection image. Any other suitable technique may be adopted to eventually extract the linework areas 12 and the original image color areas 16 from the original image 70.

The coloring picture generating routine of the embodiment uses the Gaussian filter, the edge detection filter, and the edge enhancement filter with the settings specified in advance to extract the linework areas 12 and the original image color areas 16 of the predetermined width from the original image 70. In one modification, the widths of the linework areas 12 and the original image color areas 16 to be extracted from the original image 70 may be detected by pre-scanning. The settings of the Gaussian filter, the edge detection filter, and the edge enhancement filter may then be determined dynamically and may be applied to extract the linework areas 12 and the original image color areas 16 of the predetermined width from the original image 70.

The coloring picture generating routine of the embodiment generates the area detected image 71 directly from the original image 70 at steps S110 and S120. One modified flow of the coloring picture generating routine may perform gamma conversion to convert pixels of an achromatic color (for example, black) to a darker achromatic color (deeper black) and pixels of a chromatic color to a brighter chromatic color, prior to generation of the area detected image 71. The linework areas 12 and the original image color areas 16 are extracted from the original image after conversion of the achromatic color areas of the original image to an achromatic color of a lower luminance value and the chromatic color areas of the original image to chromatic colors of higher luminance values. Such modification facilitates extraction of the linework areas 12 and the original image color areas 16 and generation of a coloring picture with reference to the color tendency of the original image.

In the embodiment described above, the watercolor effect-added coloring picture 10 is generated from the original image scanned by the scanner module 40 of the printer 20. The watercolor effect-added coloring picture 10 may also be generated from an image stored in the memory card 60 or an image input from a network (not shown) via the I/F 28.

The above embodiment regards the printer 20 as the coloring picture generating apparatus of the invention. The coloring picture generating apparatus is, however, not restricted to the printer 20 but may be any other apparatus configured to generate a coloring image including linework areas 12, original image color areas 16, and blank areas 14 from an original image, for example, a digital camera, a picture viewer, a digital video recorder, a camera-equipped cell phone, or a personal computer. The printer 20 is a multifunction printer equipped with the scanner function. The scanner module 40 may be omitted from the printer 20 or may be replaced with a facsimile module. In the printer 20 of the embodiment, the printer mechanism 31 is a color inkjet printer mechanism constructed to eject the pressurized ink onto the sheet of printing paper S for printing. The printer mechanism 31 is, however, not restricted to this color inkjet printer mechanism but may be an electrophotographic color laser printer mechanism, a thermal transfer color printer mechanism, a dot impact color printer mechanism, or a monochromatic printer mechanism of any of these types. The laser printer gives the watercolor effect-added coloring picture 10 that allows the use of water colors or oil colors for picture coloring. The above embodiment regards the printer 20, but the technique of the invention is also actualized by other applications, for example, a coloring picture generating method and a program for attaining the coloring picture generating method.

The present application claims priority from Japanese Patent Application No. 2007-194517 filed on Jul. 26, 2007, the contents of which including the specification, the drawings, and the claims disclosed therein are hereby fully incorporated by reference into this application.

What is claimed is:

1. A coloring picture, comprising:
a linework area formed as an area of line segments;
an original image color area formed along the linework area to be extended in a predetermined range from the linework area and filled with a specified color based on a color of an original image; and
a blank area formed adjacent to the original image color area.

2. The coloring picture in accordance with claim 1, wherein the linework areas are filled with an achromatic color, while the original image color area is filled with a chromatic color and is formed to have a higher luminance value than a luminance value of the linework area.

3. The coloring picture in accordance with claim 1, wherein the original image color area is formed along the linework area to have a width equivalent to or less than a width of the linework area as the predetermined range.

4. The coloring picture in accordance with claim 1, wherein the original image color area is formed along the linework area to have a width of not less than 0.5 mm and not greater than 2.0 mm as the predetermined range.

5. A coloring picture generating apparatus configured to generate a coloring image from an original image having multiple color areas, the coloring picture generating apparatus comprising:
an area extraction module configured to detect a boundary between adjacent color areas and extract a predetermined range from the detected boundary as a boundary area; and
an image generation module configured to specify a remaining area other than the extracted boundary area as a blank area and fill the extracted boundary area with a specified color based on a color of the original image, so as to generate the coloring image.

6. The coloring picture generating apparatus in accordance with claim 5, wherein the image generation module fills the extracted boundary area with the specified color of a higher luminance value than a luminance value of the color of the original image, so as to generate the coloring image.

7. The coloring picture generating apparatus in accordance with claim 5, wherein the area extraction module creates an area detection image as a basis for extraction of the boundary area, detects information on an extraction range of the boundary area from the created area detection image, and extracts the boundary area from the original image based on the detected information.

8. The coloring picture generating apparatus in accordance with claim 5, wherein the area extraction module extracts the boundary area along the boundary to have a preset width from the boundary between the adjacent color areas.

9. The coloring picture generating apparatus in accordance with claim 8, wherein the area extraction module extracts the boundary area along the detected boundary in a width of not less than 0.5 mm and not greater than 2.0 mm from the boundary as the preset width.

10. The coloring picture generating apparatus in accordance with claim 5, the coloring picture generating apparatus further having:
a print execution module to print the coloring image generated by the image generation module on a printing medium.

11. The coloring picture generating apparatus in accordance with claim 5, the coloring picture generating apparatus further having:
an image acquisition module configured to obtain the original image from an original manuscript, as a basis for extraction of the boundary area by the area extraction module.

12. A coloring picture generating method to generate a coloring image from an original image having multiple color areas, the coloring picture generating method comprising the steps of:
(a) detecting a boundary between adjacent color areas and extracting a predetermined range from the detected boundary as a boundary area; and
(b) specifying a remaining area other than the extracted boundary area as a blank area and filling the extracted boundary area with a specified color based on a color of the original image, so as to generate the coloring image.
